(19) United States
(12) Patent Application Publication
(10) Pub. No.: US 2008/0136324 A1
(43) Pub. Date: Jun. 12, 2008

(54) Arrangement Provided With at Least One Luminescent Heat-Insulating Layer on a Carrier Body

(75) Inventors: Ulrich Bast, Munchen (DE); Wolfgang Rossner, Holzkirchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/666,375

(22) PCT Filed: Oct. 25, 2005
(86) PCT No.: PCT/EP05/55530

§ 371 Date: Apr. 26, 2007

(30) Foreign Application Priority Data
Nov. 5, 2004 (EP) 04026306.3

(51) Int. Cl. H01J 1/62

(52) U.S. Cl. 313/506

(57) ABSTRACT

There is described an arrangement comprising at least one luminescent heat insulating layer which is disposed on a carrier body, for preventing heat transfer between the carrier body and the surrounding area of the carrier body. The heat insulating layer comprises at least one luminous substance which can be excited, with the aid of an excitation light having a determined excitation wave length for emitting a luminescent light having a determined luminescent wave length. At least one additional heat insulating layer, which is essentially free from the luminous substance, is provided. The additional heat insulating layer is essentially opaque to the excitation light in order to excite the emission of luminous light and/or for the luminous light of the luminescent substance. The luminous substance is, preferably, a mixed oxide which is selected from the group perowskit, having the total formula AA 03 and/or pyrochlore, having the total formula A2B207, wherein A and A′ are, respectively, a trivalent metal and B a tetravalent metal. The heat-insulating layers can be used, preferably in a gas turbine, and the state of the heat insulating layer can be examined in a simple manner.

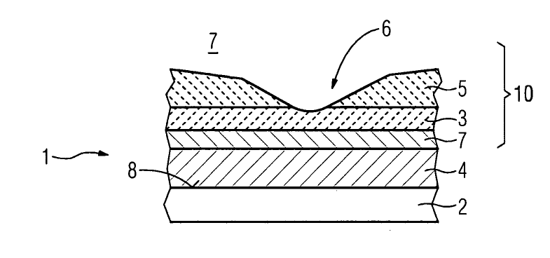

### CROSS REFERENCE TO RELATED APPLICATIONS

This application is the US National Stage of International Application No. PCT/EP2005/055530, filed Oct. 25, 2005 and claims the benefit thereof. The International Application claims the benefits of European application No. 04026306.3 EP filed Nov. 5, 2004, both of the applications are incorporated by reference herein in their entirety.

### FIELD OF INVENTION

The invention relates to an arrangement of a luminescent heat-insulating layer on a carrier body for preventing heat transfer between the carrier body and an environment of the carrier body, wherein the luminescent heat-insulating layer comprises at least one luminous substance which can be excited to emit luminescent light with a particular luminescence wavelength with the aid of excitation light having a particular excitation wavelength and wherein at least two further heat-insulating layers, which are essentially free of luminous substance, are provided.

### BACKGROUND OF INVENTION

Such an arrangement is known from EP 1 105 550 B1. The carrier body is a component of a gas turbine. The carrier body is made of a metal. Owing to a high temperature of more than 1200° C. occurring in the environment of the component in a gas turbine, damage to the metal of the component may take place. In order to prevent this, a heat-insulating layer (thermal barrier coating, TBC) is applied on the component. The heat-insulating layer ensures that reduced heat exchange takes place between the carrier body made of the metal and the environment. A metal surface of the component is therefore heated less. A surface temperature, which is lower than the temperature in the environment of the component, occurs on the metal surface of the component.

The heat-insulating substance forms a base material of the heat-insulating layer. The mechanical and thermal properties of the heat-insulating layer depend essentially on the properties of the heat-insulating substance. The base material of the known heat-insulating layer is a metal oxide. This metal oxide is, for example, an yttrium stabilized zirconium oxide (YSZ). A thermal conductivity of this heat-insulating layer lies between 1 W/m·K and 3 W/m·K. In order to ensure efficient protection of the carrier body, a layer thickness of the heat-insulating layer is about 250 μm. As an alternative to yttrium stabilized zirconium oxide, a metal oxide in the form of an yttrium aluminum garnet is indicated as a heat-insulating substance.

In order to firmly bond the heat-insulating layer and the carrier body, a metallic interlayer (bond coat) of a metal alloy is applied on the surface of the component. In order to improve the bonding, a ceramic interlayer of a ceramic material, for example aluminum oxide, may additionally be arranged between the heat-insulating layer and the component.

A so-called thermoluminescent indicator is embedded into the heat-insulating layer. This indicator is a luminous substance (luminophore) which can be excited to emit luminescent light with a particular emission wavelength by excitation with excitation light of a particular excitation wavelength. The excitation light is, for example, UV light. The emission light is, for example, visible light. The luminous substance used is a so-called recombination luminous substance. The luminous process is induced by electronic transitions between energy states of the activator. Such a luminous substance consists for example of a solid body with a crystal lattice (host lattice), into which a so-called activator is embedded. The solid body is doped with the activator. The activator, together with the entire solid body, is involved in the luminous process of the luminous substance.

In the known heat-insulating layer, the respective base material of the heat-insulating layer is doped with an activator. A heat-insulating layer comprising the luminous substance is therefore provided. The activator used therefor is respectively a rare earth element. In the case of yttrium stabilized zirconium oxide, the rare earth element is for example europium. The heat-insulating substance yttrium aluminum garnet is doped with the rare earth elements dysprosium or terbium.

In the case of the known heat-insulating layer, use is made of the fact that an emission property of the luminescent light of the luminous substance, for example an emission intensity or an emission decay time, depends on the luminous substance temperature of the luminous substance. The temperature of the heat-insulating layer comprising the luminous substance is deduced on the basis of this dependency. So that this relationship can be established, the heat-insulating layer is optically accessible for the excitation light in the UV range. At the same time, it is ensured that the luminescent light of the luminous substance can be emitted from the heat-insulating layer and detected.

In order to ensure optical accessibility, for example, only a single heat-insulating layer comprising the luminous substance is arranged on the carrier body. As an alternative solution to this, a further heat-insulating layer, which is transparent for the excitation light and the luminescent light of the luminous substance, is applied on the heat-insulating layer. The luminescent light of the luminous substance can pass through the further heat-insulating layer.

In order to check the status of the heat-insulating layer, a relatively complicated structure is needed for exciting the luminous substance and for detecting the luminescent light of the luminous substance.

### SUMMARY OF INVENTION

It is therefore an object of the present invention to provide an arrangement having a heat-insulating layer with a luminescent heat-insulating substance, which allows simple determination of a status of the heat-insulating layer on a carrier body.

In order to achieve the object, an arrangement of a luminescent heat-insulating layer on a carrier body for restricting heat transfer between the carrier body and an environment of the carrier body is provided, wherein the luminescent heat-insulating layer comprises at least one luminous substance which can be excited to emit luminescent light with a particular luminescence wavelength with the aid of excitation light having a particular excitation wavelength, and wherein at least two further heat-insulating layers are provided, which are essentially free of the luminous substance. The luminescent heat-insulating layer is arranged between the further heat-insulating layers.

The luminescent heat-insulating layer comprising the luminous substance may be present as a single phase or multiple phases. Single phase means that a ceramic phase of the luminescent heat-insulating layer, formed by the heat-insulating substance, essentially consists only of the luminous substance. The heat-insulating substance of the luminescent heat-insulating layer is the luminous substance. In the case of a multiphase heat-insulating layer, the heat-insulating substance and the luminous substance are different. Luminous substance particles of the luminous substance are contained in the heat-insulating substance. The ceramic phase is formed by different materials. The luminous substance particles are preferably distributed homogeneously over the heat-insulating layer. It is furthermore advantageous for the heat-insulating substance and the luminous substance to consist of an essentially identical type of solid body. The two substances differ merely by the optical properties. To this end, for example, the luminous substance is doped.

In a particular configuration, the arrangement is characterized in that the outer further heat-insulating layer is essentially opaque for the excitation light to excite the emission of luminescent light and/or for the luminescent light of the luminous substance, so that the excitation light of the luminous substance and/or the luminescent light of the luminous substance can reach the environment of the carrier body essentially only through openings of the further heat-insulating layer. Such openings are, for example, cracks or gaps in the further heat-insulating layer. An opening, which has been formed by erosion (removal) of the further heat-insulating substance of the further heat-insulating layer, may also be envisaged. These openings can readily be made visible. They are made visible by illuminating the arrangement with the excitation light. At the positions where the UV light passes through the openings onto the heat-insulating layer comprising the luminous substance, the luminous substance is excited to emit the luminescent light. The luminescent light passes through the openings into the environment of the carrier body, where it can be detected. Owing to the openings, luminescent light emerges which stands out clearly from the background in respect of its intensity.

Opaque in this case means that the excitation light and/or the luminescent light cannot or virtually cannot pass through the further heat-insulating layer, owing to the transmission or absorption properties of the further heat-insulating layer. Essentially means here that under certain circumstances there may be minor transmissivity for the excitation light and/or the luminescent light.

In the described way, during an operational pause of a device, the heat-insulating layer of a carrier body used in the device can be checked simply and reliably. The device is, for example, a gas turbine. The carrier body is, for example, a turbine blade of the gas turbine. The multilayer structure comprising the heat-insulating layers is located on the turbine blade. Those positions of the further, outermost heat-insulating layer which comprise openings are made visible by illuminating the turbine blade and observing the luminescent light of the luminous substance.

It is nevertheless also conceivable for a check of the status of the heat-insulating layer to be carried out during operation of the device. To this end, for example, a combustion chamber of the aforementioned gas turbine, in which the turbine blades are used, is provided with windows through which the luminescence of the luminous substance can be observed. The emergence of luminescent light is an indication that the further, outermost heat-insulating layer of at least one turbine blade has a crack or a gap, i.e. it is eroded.

Another advantage of the described arrangement is that a heat-insulating substance comprising the luminous substance will also be removed as a result of progressive erosion. By corresponding detectors, the luminous substance can be detected in an exhaust gas of the gas turbine. This is an indication that erosion has advanced as far as the heat-insulating layer comprising the luminous substance.

Any desired ceramic luminous substance, which can be used in a heat-insulating layer, may be envisaged as the luminous substance. In a particular configuration, the luminous substance comprises at least one metal oxide having at least one trivalent metal A. Such a luminous substance is for example an yttrium stabilized or semi-stabilized zirconium oxide doped with an activator. In particular, luminous substances in the form of perovskites and pyrochlores may also be envisaged.

Said luminous substances are so-called recombination luminous substance. The emission of the luminescent light is in this case preferably based on the presence of an activator. With the aid of an activator or a plurality of activators, the emission property of the luminous substance, for example the emission wavelength and the emission intensity, can be varied in a relatively straightforward way.

In a particular configuration, the luminous substance comprises an activator selected from the group cerium and/or europium and/or dysprosium and/or terbium to excite the emission of the luminescent light. Owing to their ionic radii, rare earth elements can generally be incorporated very well into the crystal lattices of metal oxides such as perovskites and pyrochlores. Activators in the form of rare earth elements are therefore generally suitable. The listed rare earth elements have proven to be particularly good activators.

When using an activator, its proportion in the luminous substance is selected so that the thermal and mechanical properties of the metal oxide of the luminous substance are virtually unaffected. The mechanical and thermal properties of the metal oxide are preserved in spite of doping. In a particular configuration, the luminous substance contains the activator in a proportion of up to 10 mol %. The proportion is preferably less than 2 mol %. For example, the proportion is 1 mol %. It has been found that this low proportion of the activator is sufficient to achieve an evaluable emission intensity of the luminous substance. The thermal and mechanical stability of a heat-insulating layer produced with the luminous substance is in this case maintained.

In a particular configuration, the metal oxide of the luminous substance is a mixed oxide selected from the group perovskite with the empirical formula AA′O3 and/or pyrochlore with the empirical formula A2B2O7, where A′ is a trivalent metal and B is a tetravalent metal. A heat-insulating layer made of a perovskite and/or a pyrochlore (pyrochlore phase) is distinguished by high stability in relation to temperatures of more than 1200° C. The arrangement is therefore suitable for new gas turbine generations, in which an increased efficiency is intended to be achieved by increasing the working temperature.

In a particular configuration, the trivalent metal A and/or the trivalent metal A′ is a rare earth element Re. The trivalent metal A and/or the trivalent metal A′ is, in particular, a rare earth element selected from the group lanthanum and/or gadolinium and/or samarium. Other rare earth elements may likewise be envisaged. By using a perovskite and/or a pyrochlore with these rare earth elements, owing to the similar ionic radii, an activator in the form of a rare earth element can very easily be incorporated into the crystal lattice of the perovskite or the pyrochlore.

One of the trivalent metals A and A′ of the perovskite is a main group or subgroup element. The tetravalent metal B of the pyrochlore is likewise a main or subgroup element. In both cases, mixtures of different main and subgroup elements may be provided. Owing to the different ionic radii, the rare earth elements and the main or subgroup elements preferentially occupy different sites in the perovskite or pyrochlore crystal lattice. Aluminum has in this case proven particularly suitable as a trivalent main group element. Together with rare earth elements, for example, aluminum forms a perovskite which leads to a mechanically and thermally stable heat-insulating layer. In a particular configuration, the perovskite is therefore a rare earth aluminate. The empirical formula reads ReAlO3, where Re stands for a rare earth element. The rare earth aluminate is preferably a gadolinium lanthanum aluminate. The empirical formula reads, for example, Gd0.25La0.75AlO3. In particular, the subgroup elements hafnium and/or titanium and/or zirconium are used as the tetravalent metal B of the pyrochlore. The pyrochlore is therefore preferably selected from the group rare earth titanate and/or rare earth hafnate and/or rare earth zirconate. In particular, the rare earth zirconate is selected from the group gadolinium zirconate and/or samarium zirconate. The preferred empirical formulae read Gd2Zr2O7 and Sm2Zr2O7. The rare earth hafnate is preferably lanthanum hafnate. The empirical formula reads La2Hf2O7.

The excitation of the luminous substance to emit luminescent light is carried out optically. The luminous substance is in this case exposed to excitation light of a particular excitation wavelength. By absorbing the excitation light, the luminous substance is excited to emit luminescent light. The excitation light is for example UV light, and the luminescent light low-energy visible light.

Excitation of the luminous substance with excitation light is suitable for checking a status of a heat-insulating layer, comprising the luminous substance, which is optically accessible for the excitation light and the luminescent light. To this end, for example, only the heat-insulating layer comprising the luminous substance is applied on the carrier body.

In a particular configuration, the carrier body is a component of a combustion engine. The combustion engine is, for example, a diesel engine. In a particular configuration, the combustion engine is a gas turbine. The carrier body may in this case be a panel with which a combustion chamber of the gas turbine is clad. In particular, the carrier body is a turbine blade of the gas turbine. It is in this case conceivable for the different carrier bodies to be provided with heat-insulating layers comprising luminous substances, which emit different luminescent light. In this way, it is readily possible to determine the component on which damage exists.

In order to apply the heat-insulating layer and the further heat-insulating layer, any desired coating method may be carried out. The coating method is, in particular, a plasma spraying method. The coating method may also be a vapor deposition method, for example PVD (physical vapor deposition) or CVD (chemical vapor deposition). With the aid of the said methods, heat-insulating layers are applied with a layer thicknesses of from 50 μm to 600 μm or more.

### BRIEF DESCRIPTION OF THE DRAWINGS

The invention will be explained in more detail below with the aid of several exemplary embodiments and an associated FIGURE. The FIGURE is schematic and does not represent images which are true to scale.

The FIGURE shows a detail of a lateral cross section of an arrangement of a luminescent heat-insulating layer comprising a heat-insulating substance with a luminous substance, and two further heat-insulating layers having a further heat-insulating substance from the side.

### DETAILED DESCRIPTION OF INVENTION

The arrangement 1 consists of a carrier body 2 on which a luminescent heat-insulating layer 3 and further, here for example two, heat-insulating layers 5, 7 are arranged. The carrier body 2 is, for example, a turbine blade of a gas turbine. The turbine blade, for example, is made of a metal. In the combustion chamber of the gas turbine, which constitutes the environment 7 of the carrier body 2, temperatures of more than 1200° C. can occur during operation of the gas turbine. In order to avoid overheating the surface 8 of the carrier body 2, the heat-insulating layer 10 is provided. The heat-insulating layer 10 is used to restrict heat transfer between the carrier body 2 and the environment 7 of the carrier body 2.

A multilayer structure is provided comprising the heat-insulating layer 10, a metallic interlayer 4 (bond coat) of a metal alloy, a luminescent heat-insulating layer 3 and further heat-insulating layers 5, 7. The luminescent heat-insulating layer 3, comprising the luminous substance, is arranged between the further heat-insulating layers 5, 7. In particular, only a single luminescent heat-insulating layer 3 is provided.

The further outer heat-insulating layer 5 is, for example, opaque for the excitation light and/or the luminescent light of the luminous substance. Only when the further heat-insulating layer 5 has an opening 6, can the luminescent light of the luminescence substance be detected in the environment 7 of the carrier body 2.

### EXAMPLE 1

The heat-insulating substance for the luminescent heat-insulating layer 3 is a metal oxide in the form of a rare earth aluminate with the empirical formula Gd0.25La0.75AlO3. According to a first embodiment, 1 mol % of Eu2O3 is added to the rare earth aluminate. The rare earth aluminate comprises the activator europium in a proportion of 1 mol %. Excitation of the luminous substance with UV light results in red luminescent light with an emission maximum at about 610 nm. The excitation wavelength is, for example, 254 nm.

According to an alternative embodiment to this, the rare earth aluminate is doped with 1 mol % of terbium. This results in a luminous substance having green luminescent light with an emission wavelength at about 544 nm.

### EXAMPLE 2

The luminescent heat-insulating layer 3 consists of a pyrochlore. The pyrochlore is a gadolinium zirconate with the empirical formula Gd2Zr2O7. In order to produce the luminous substance,

1 mol % of Eu2O3 is added to the pyrochlore. The gadolinium zirconate comprises the activator europium in a proportion of 1 mol %.

### EXAMPLE 3

The luminescent heat-insulating layer 3 consists of an yttrium stabilized zirconium oxide. In order to produce the luminous substance, 1 mol % of Eu2O3 is added to the yttrium stabilized zirconium oxide. The yttrium stabilized zirconium oxide comprises the activator europium in a proportion of 1 mol %.

The heat-insulating substances of the further heat-insulating layers 5, 7 correspond, for example, to that of the luminescent heat-insulating layer 3 without doping, although they may also consist of other materials.

The heat-insulating substances of the further heat-insulating layers 5, 7 may be identical or different.

1.-17. (canceled)

18. An arrangement of a luminescent heat-insulating layer on a carrier body, comprising:
a first heat-insulating layer essentially opaque for an excitation light to excite the emission of luminescent light; and
a second heat insulating layer, wherein the luminescent heat-insulating layer is arranged between the first heat-insulating layer and the second heat-insulating layer.

19. The arrangement as claimed in claim 18,
wherein the luminescent heat-insulating layer comprises at least one luminous substance to emit luminescent light with a particular luminescence wavelength based upon excitation light having a particular excitation wavelength,
wherein the luminescent heat-insulating layer restricts a heat transfer between the carrier body and an environment of the carrier body, and
wherein the first heat insulating layer and the second heat insulating layer are essentially free of the luminous substance.

20. The arrangement as claimed in claim 18, wherein the first heat insulating layer is an outer heat-insulating layer having openings for a luminescent emission.

21. The arrangement as claimed in claim 19, wherein the luminous substance comprises at least one metal oxide having at least one trivalent metal.

22. The arrangement as claimed in claim 19, wherein the luminous substance comprises an activator selected from the group consisting of: cerium, europium, dysprosium, terbium, and a combination thereof.

23. The arrangement as claimed in claim 18, wherein the luminescent heat-insulating layer has a luminous substance, wherein the luminous substance has an activator in a proportion of up to 10 mol %.

24. The arrangement as claimed in claim 21, wherein the metal oxide is a mixed oxide from a perovskite group with the empirical formula AA′O₃, wherein A and A′ are trivalent metals.

25. The arrangement as claimed in claim 21, wherein the metal oxide is a mixed oxide from a pyrochlore group with the empirical formula A₂B₂O₇, where A and A′ are a trivalent metal and B is a tetravalent metal.

26. The arrangement as claimed in claim 24, wherein the trivalent metal is a rare earth element Re.

27. The arrangement as claimed in claim 24, wherein the trivalent metal is selected from the group consisting of: lanthanum, gadolinium, samarium, and a combination thereof.

28. The arrangement as claimed in claim 24, wherein the perovskite is a rare earth aluminate.

29. The arrangement as claimed in claim 28, wherein the empirical formula of the rare earth aluminate is Gd_{0.25}La_{0.75}AlO₃.

30. The arrangement as claimed in claim 25, wherein the pyrochlore is selected from the group consisting of: rare earth hafnate, rare earth titanate, rare earth zirconate, and a combination thereof.

31. The arrangement as claimed in claim 30, wherein the rare earth zirconate is selected from the group consisting of: gadolinium zirconate, samarium zirconate, and a combination thereof.

32. The arrangement as claimed in claim 30, wherein the rare earth hafnate is lanthanum hafnate.

33. The arrangement as claimed in claim 18, wherein the carrier body is a component of a combustion engine.

34. The arrangement as claimed in claim 33, wherein the combustion engine is a gas turbine.

35. An arrangement of a luminescent heat-insulating layer on a carrier body, comprising:
a first heat-insulating layer essentially opaque for a luminescent light of a luminous substance in the luminescent heat-insulating layer; and
a second heat insulating layer, wherein the luminescent heat-insulating layer is arranged between the first heat-insulating layer and the second heat-insulating layer.

36. The arrangement as claimed in claim 35,
wherein the luminescent heat-insulating layer comprises at least one luminous substance which can be excited to emit luminescent light with a particular luminescence wavelength with the aid of excitation light having a particular excitation wavelength,
wherein the luminescent heat-insulating layer restricts a heat transfer between the carrier body and an environment of the carrier body, and
wherein the first heat insulating layer and the second heat insulating layer are essentially free of the luminous substance.

37. The arrangement as claimed in claim 35, wherein the first heat insulating layer is an outer heat-insulating layer having openings for luminescent emission.
